(19) United States
(12) Patent Application Publication
(10) Pub. No.: US 2022/0200667 A1
(43) Pub. Date: Jun. 23, 2022

(54) APPARATUS, METHOD AND COMPUTER PROGRAM

(71) Applicant: Nokia Technologies Oy, Espoo (FI)

(72) Inventors: Salah Eddine HAJRI, Antony (FR); Rana AHMED SALEM, Munich (DE); Filippo TOSATO, Bures Sur Yvette (FR); Marco MASO, Issy les Moulineaux (FR)

(21) Appl. No.: 17/605,253

(22) PCT Filed: May 7, 2019
(86) PCT No.: PCT/EP2019/061703

§ 371 Date: Oct. 21, 2021

(51) Int. Cl. H04B 7/0417; H04B 7/0456; H04L 5/00

(52) U.S. Cl. CPC H04B 7/0417; H04L 5/0051; H04B 7/0486

(57) ABSTRACT

There is provided an apparatus, said apparatus comprising means for receiving a multiple input multiple output signal from a network, determining a frequency domain basis subset for each layer of the multiple input multiple output signal, determining from the frequency domain basis subset a number, M_{C}, of frequency domain components common to each layer, determining, from the frequency domain basis subset, a number of layer-specific frequency domain components and providing to the network, in uplink control information, an indication of the frequency domain components common to each layer and the layer-specific frequency domain components.

### FIELD

The present application relates to a method, apparatus, system and computer program and in particular but not exclusively to uplink control information (UCI) design for high rank channel state information (CSI) feedback.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices (also referred to as station or user equipment) and/or application servers. The communication sessions may comprise, for example, communication of data for carrying communications such as voice, video, electronic mail (email), text message, multimedia, content data, time-sensitive network (TSN) flows and/or data in an industrial application such as critical system messages between an actuator and a controller, critical sensor data (such as measurements, video feed etc.) towards a control system and so on. Non-limiting examples of services provided comprise two-way or multi-way calls, data communication or multimedia services and access to a data network system, such as the Internet.

In a wireless communication system at least a part of a communication session, for example, between at least two stations or between at least one station and at least one application server (e.g. for video), occurs over a wireless link. Examples of wireless systems comprise public land mobile networks (PLMN) operating based on 3GPP radio standards such as E-UTRA, New Radio, satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access one or more carriers provided by the network, for example a base station of a cell, and transmit and/or receive communications on the one or more carriers.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) based on the E-UTRAN radio-access technology, and so-called 5G system (5GS) including the 5G or next generation core (NGC) and the 5G Access network based on the New Radio (NR) radio-access technology. 5GS including NR are being standardized by the 3rd Generation Partnership Project (3GPP).

### SUMMARY

In a first aspect there is provided an apparatus comprising means for receiving a multiple input multiple output signal from a network, determining a frequency domain basis subset for each layer of the multiple input multiple output signal, determining from the frequency domain basis subset a number, M_{C}, of frequency domain components common to each layer, determining, from the frequency domain basis subset, a number of layer-specific frequency domain components and providing to the network an indication of the frequency domain components common to each layer and the layer-specific frequency domain components.

The apparatus may comprise means for providing the indication in uplink control information.

The apparatus may comprise means for determining the frequency domain basis subset for each layer independently, commonly or in a partially common manner.

The apparatus may comprise means for determining M_{C} such that a maximum number of non-zero coefficients are concentrated in the M_{C} frequency domain components.

M_{C} may be determined from a predefined number of layers.

The predefined number of layers may be the first two layers of the layers or any combination of the layers.

The apparatus may comprise means for determining non-zero coefficients commonly mapped to each layer and providing an indication of the non-zero coefficients to the network.

The apparatus may comprise means for determining non-zero coefficients that are mapped independently per layer and providing an indication of the non-zero coefficients to the network.

The apparatus may comprise means for providing the indication of the non-zero coefficients in uplink control information.

The signal may be a channel state information reference signal.

In a second aspect there is provided a method comprising receiving a multiple input multiple output signal from a network, determining a frequency domain basis subset for each layer of the multiple input multiple output signal, determining from the frequency domain basis subset a number, M_{C}, of frequency domain components common to each layer, determining, from the frequency domain basis subset, a number of layer-specific frequency domain components and providing to the network an indication of the frequency domain components common to each layer and the layer-specific frequency domain components.

The method may comprise providing the indication in uplink control information.

The method may comprise determining the frequency domain basis subset for each layer independently, commonly or in a partially common manner.

The method may comprise determining M_{C} such that a maximum number of non-zero coefficients are concentrated in the M_{C} frequency domain components.

M_{C} may be determined from a predefined number of layers.

The predefined number of layers may be the first two layers of the layers or any combination of the layers.

The method may comprise determining non-zero coefficients commonly mapped to each layer and providing an indication of the non-zero coefficients to the network.

The method may comprise determining non-zero coefficients that are mapped independently per layer and providing an indication of the non-zero coefficients to the network.

The method may comprise providing the indication of the non-zero coefficients in uplink control information.

The signal may be a channel state information reference signal.

In a third aspect there is provided an apparatus comprising at least one processor and at least one memory including a computer program code, the at least one memory and computer program code configured to, with the at least one processor, cause the apparatus at least to receive a multiple input multiple output signal from a network, determine a frequency domain basis subset for each layer of the multiple input multiple output signal, determine from the frequency domain basis subset a number, M_{C}, of frequency domain components common to each layer, determine, from the frequency domain basis subset, a number of layer-specific frequency domain components and provide to the network an indication of the frequency domain components common to each layer and the layer-specific frequency domain components.

The apparatus may be configured to provide the indication in uplink control information.

The apparatus may be configured to determine the frequency domain basis subset for each layer independently, commonly or in a partially common manner.

The apparatus may be configured to determine M_{C} such that a maximum number of non-zero coefficients are concentrated in the M_{C} frequency domain components.

M_{C} may be determined from a predefined number of layers.

The predefined number of layers may be the first two layers of the layers or any combination of the layers.

The apparatus may be configured to determine non-zero coefficients commonly mapped to each layer and provide an indication of the non-zero coefficients to the network.

The apparatus may be configured to determine non-zero coefficients that are mapped independently per layer and provide an indication of the non-zero coefficients to the network.

The apparatus may be configured to provide the indication of the non-zero coefficients in uplink control information.

The signal may be a channel state information reference signal.

In a fourth aspect there is provided a computer readable medium comprising program instructions for causing an apparatus to perform at least the following receiving a multiple input multiple output signal from a network, determining a frequency domain basis subset for each layer of the multiple input multiple output signal, determining from the frequency domain basis subset a number, MC, of frequency domain components common to each layer, determining, from the frequency domain basis subset, a number of layer-specific frequency domain components and providing to the network an indication of the frequency domain components common to each layer and the layer-specific frequency domain components.

The apparatus may be caused to perform providing the indication in uplink control information.

The apparatus may be caused to perform determining the frequency domain basis subset for each layer independently, commonly or in a partially common manner.

The apparatus may be caused to perform determining M_{C} such that a maximum number of non-zero coefficients are concentrated in the M_{C} frequency domain components.

M_{C} may be determined from a predefined number of layers.

The predefined number of layers may be the first two layers of the layers or any combination of the layers.

The apparatus may be caused to perform determining non-zero coefficients commonly mapped to each layer and providing an indication of the non-zero coefficients to the network.

The apparatus may be caused to perform determining non-zero coefficients that are mapped independently per layer and providing an indication of the non-zero coefficients to the network.

The apparatus may be caused to perform providing the indication of the non-zero coefficients in uplink control information.

The signal may be a channel state information reference signal.

In a fifth aspect there is provided a non-transitory computer readable medium comprising program instructions for causing an apparatus to perform at least the method according to the second aspect.

In the above statements, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram of an example mobile communication device;

FIG. 3 shows a schematic diagram of an example control apparatus;

FIG. 4 shows a schematic diagram of non-zero coefficients (NZC) mapping for FD compression of Type II CSI feedback;

FIG. 5 shows a flowchart of a method according to an example embodiment;

FIG. 6 shows a schematic diagram of NZC mapping and FD component selection according to an example embodiment;

FIG. 7 shows a schematic diagram of a procedure at a UE and a gNB according to an example embodiment;

FIG. 8 shows a schematic diagram of a procedure at a UE and a gNB according to an example embodiment;

FIG. 9 shows a schematic diagram of a procedure at a UE and a gNB according to an example embodiment.

### DETAILED DESCRIPTION

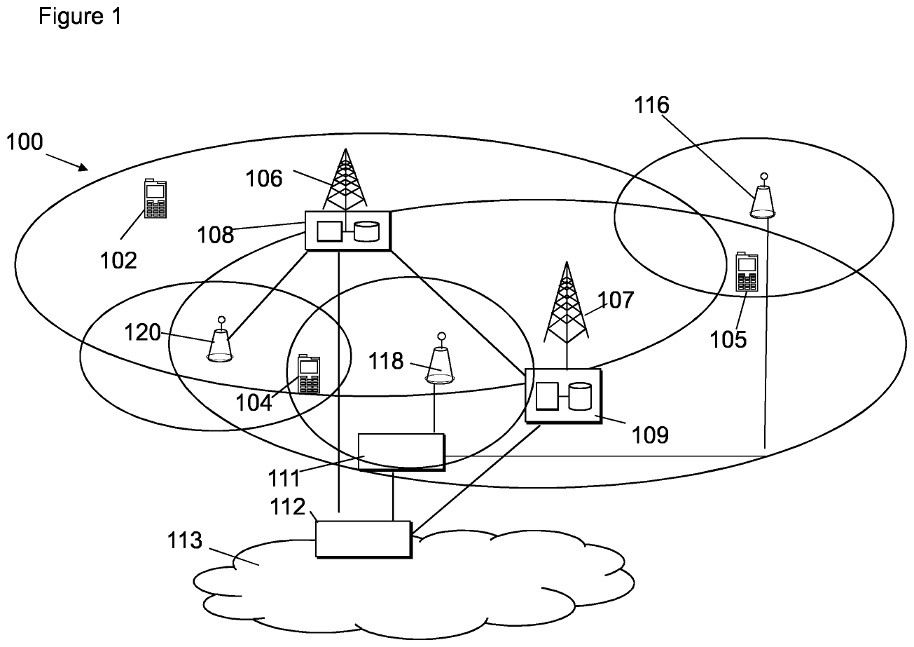

Before explaining in detail the examples, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices or user equipment (UE) 102, 104, 105 are provided wireless access via at least one base station (e.g. next generation NB, gNB) or similar wireless transmitting and/or receiving node or point. Base stations may be controlled or assisted by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatuses. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example WLAN and may be WLAN APs.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). One3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE (LTE-A) employs a radio mobile architecture known as the Evolved Universal Terrestrial Radio Access Network (E-UTRAN) and a core network known as the Evolved Packet Core (EPC). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area. Core network elements include Mobility Management Entity (MME), Serving Gateway (S-GW) and Packet Gateway (P-GW).

An example of a suitable communications system is the 5G or NR concept. Network architecture in NR may be similar to that of LTE-advanced. Base stations of NR systems may be known as next generation Node Bs (gNBs). Changes to the network architecture may depend on the need to support various radio technologies and finer QoS support, and some on-demand requirements for e.g. QoS levels to support QoE of user point of view. New functions are defined in the 5G system architecture, including an Access Management Function (AMF), Session Management Function (SMF), User Plane Function (UPF), among other network functions in the Next Generation Core (NGC). The 5G System supports new capabilities, including network slicing which may better tailor networks to application requirements and provide virtual networks for tenants. It also uses a services-based architecture the provides greater flexibility for introducing new services and features compared to the EPC which relied on fixed, peer-peer reference points. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates. MR may also support lower latency for air-interface transmission due to revisions in physical and MAC layer protocols.

Future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, by a Centralized Unit (CU) at least partly, in a server, host or node operationally coupled to Distributed Unit (DU), which may connect to a remote radio head (RRH). It is also possible that node operations will be distributed among a plurality of servers, nodes or hosts. It should also be understood that the distribution of labour between core network operations and base station operations may differ from that of the LTE or even be non-existent.

An example 5G core network (CN) comprises functional entities. The CN is connected to a UE via the radio access network (RAN). An UPF (User Plane Function) which may be a PSA (PDU Session Anchor) providing an anchor point for user IP, Ethernet or Unstructured user data sessions. The UPF may be responsible for forwarding frames back and forth between the DN (data network) and the gNBs through tunnels established over transport networks towards the UE(s) that want to exchange traffic with the DN.

The UPF is controlled by an SMF (Session Management Function) that receives policies from a PCF (Policy Control Function). The CN may also include an AMF (Access & Mobility Function) which terminates the control plane interface with the RAN and manages UE registrations and mobility.

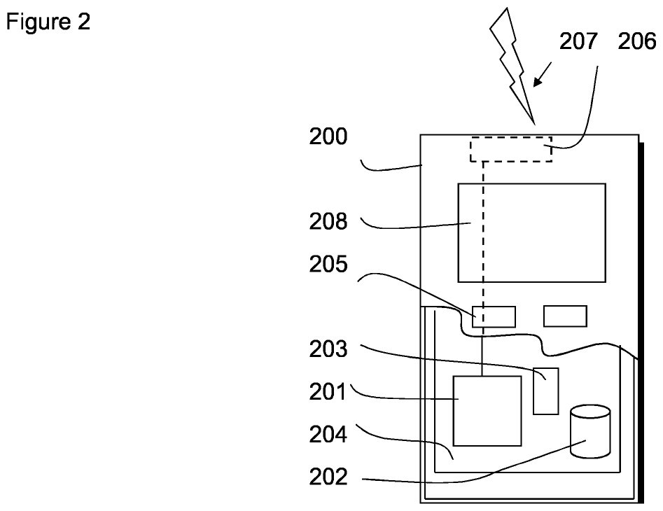

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

In an industrial application a communication device may be a modem integrated into an industrial actuator (e.g. a robot arm) and/or a modem acting as an Ethernet-hub that will act as a connection point for one or several connected Ethernet devices (which connection may be wired or unwired).

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

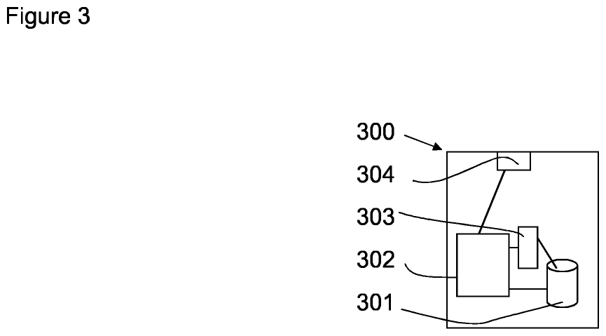

FIG. 3 shows an example embodiment of a control apparatus for a communication system, for example to be coupled to and/or for controlling a station of an access system, such as a RAN node, e.g. a base station, eNB or gNB, a relay node or a core network node such as an MME or S-GW or P-GW, or a core network function such as AMF/SMF, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus, such as a CU Control Plane (CU-CP) as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

To face the ever-increasing demand for mobile traffic and the proliferation of new services, 5G NR supports a wide range of services with demanding KPIs. To meet its performance goals, 5G NR may rely on technologies including MU-MIMO.

MIMO technology may deliver the expected increase in spectral efficiency and improve reliability. MU-MIMO enables the spatial multiplexing of a large number of devices while enhancing the radio-link reliability and performance. In addition, MIMO may be used for high carrier frequencies (FR2, FR3) where a beamformed air interface guarantees coverage.

MIMO BSs use transmit precoding and receive combining to enable the spatial multiplexing of many UE terminals with increased spectral efficiency and reliability. However, this gain is conditioned on the availability of accurate channel state information which can be obtained from uplink or downlink reference signals (CSI-RS, SRS). A MIMO signal may be considered to have a plurality of layers, one for each antenna, or rank indicator (RI).

The performance of MIMO comes from its ability to concentrate radiated energy on specific targets. However, this ability is only possible when accurate and timely CSI estimation is obtained at the BS side. The precision of beamforming, which is the cornerstone of multi-antenna processing, depends on the accuracy of the obtained CSI estimates. Obtaining accurate CSI estimates from the UE may be challenging due to the required signalling and processing overhead.

In Release 15 NR MIMO, two types of CSI feedback were specified, namely, Type I and Type II. To achieve enhanced CSI resolution, i.e., acquire CSI estimates with finer granularity, Type II CSI feedback was specified in Rel. 15 NR. Type II CSI feedback may provide high accuracy leveraging the linear combination of oversampled 2D DFT beams. However, this improved accuracy may come at the price of large feedback overhead. The UE is expected to feedback the indices of the selected beams and the associated wideband and subband coefficients. The resulting overhead prompted the development of several methods of Type II overhead reduction.

Several type II CSI feedback compression schemes have been proposed including FD compression based on DFT subset basis. Leveraging correlation of the channel across subbands, FD compression may reduce the feedback overhead. In RAN1 #95, DFT-based FD compression was approved as the supported mechanism for type II overhead reduction for ranks 1 and 2.

3GPP retained the most promising of the Type II overhead reduction method for MU CSI enhancement in Release 16, namely, FD type II CSI compression. Based on a DFT basis, FD compression may enable good trade-off between performance and overhead for rank 1-2. Enhancement of type II CSI feedback for Rel. 16 was agreed in 3GPP. Since support for RI>2 provides flexibility and performance improvement, the extension of type II CSI for higher ranks was agreed by 3GPP.

In the agreed framework for type II CSI FD compression for Rel. 16 NR, feedback overhead reduction is implemented through a FD compression scheme applied on Rel. 15 Type II PMI parameters.

The precoder for each layer and across frequency-domain units W is derived as follows

W=W₁\tilde{W}₂W_{f}^{H}

Where W is of size ((2N₁N₂)×N₃). The rows and columns of W correspond to the spatial and frequency domain reporting subbands, respectively. W₁ is defined as in Rel. 15 type II and corresponds to the spatial-domain basis (L beams per polarization).

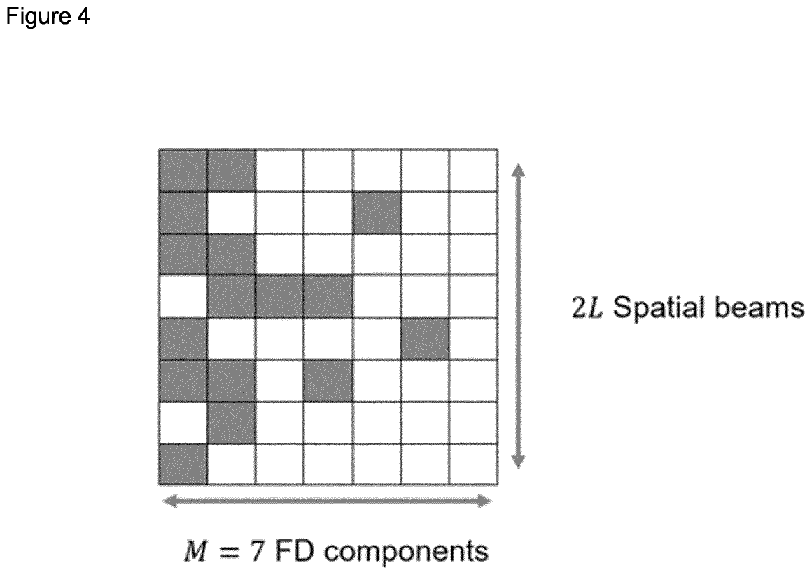

\tilde{W}₂ denotes the matrix of linear combination coefficients including amplitude and co-phasing. Finally, W_{f} denotes the FD DFT-basis subset which is used for compression. W_{f} is of size N₃×M, where M denotes the number of selected FD components. Consequently, the overhead payload for FD compressed type II CSI includes the necessary bits to convey the indices of selected SD beams β_{SD} for all layers, and for each layer, the number and indices of K₁ non-zero linear combination coefficients (β_{bitmap}+β_{K}_{₀}), the indices of the selected FD components β_{FD}, the index of the strongest coefficient and the values of the amplitude βₐ and co-phasing βₚ. The indices of the non-zero coefficients are indicated through a bitmap per layer as depicted in FIG. 4.

Consequently, the total payload when compressed type II CSI is independently processed per layer may be given by:

β_{SD}+(β_{bitmap}+β_{FD}+β_{K}_{₀}+βₐ+βₚ)×RI

The resulting overhead increment as a function of the channel rank is prohibitive. Avoiding a substantial increase in CSI overhead for ranks higher than one is, consequently, critical. For example, the total overhead for rank 4 can be twice that of rank 2 which may be impractical.

To support ranks 3 and 4, proper adaptation of DFT-based FD compression is necessary. Maintaining the current FD compression approach for ranks higher or equal to 2 may result in a problematic overhead that scales with the rank indicator. A simple extension, without additional optimization, will result in an unacceptable increase of 3-4-fold in overhead over rank 1 (linear increment in overhead with respect to rank). That is, extension of the current FD compression framework to high rank channels is needed.

However, it may not be straightforward to extend Type II CSI for higher ranks. Since the FD compression framework requires feeding back the indices of the selected beams, the indices of selected FD basis subset, a set of non-zero linear combination coefficients and their indices in a bitmap a simplistic extension of type II CSI to ranks higher than 2, without additional optimization, may not be practical. Indeed, the overhead for rank 4 may be twice that of rank 2.

Toward the reduction of CSI overhead for RI=3-4, an agreement was reached in RAN1 #96 to consider several alternatives for SD and FD basis selection. To maintain the overhead increment acceptable for high rank channels, an agreement was reached to down select from RI-common or RI specific SD parameter L for RI∈{3,4} and layer-common or layer-/layer-group-specific FD parameter p and the combinations thereof.

In addition, several alternatives for defining the maximum number of non-zero coefficients for RI∈{3,4} are currently under study. The final design of the UCI and the bitmaps which indicate the locations of the non-zero coefficients will be the next step toward finalising the design for MU CSI enhancement.

Two aspects need to be addressed in order to fully leverage the potential of MIMO.

First, feedback overhead should be reduced. Reducing feedback overhead may enable an increase in the feedback resolution in the spatial domain and support extension to ranks greater than 2, which is the second aspect to be addressed. Decreasing the CSI reporting overhead is of importance since the saved resources may be used to improve spatial resolution which ultimately results in higher spectral efficiency.

In the ongoing 3GPP meeting, two alternatives for FD basis subset selection are proposed, namely, independent and common.

Nevertheless, due to the DFT basis properties, the FD components that will be selected for FD compression, in each layer, are most likely correlated. One can leverage this correlation in order to reduce the number of bits that are needed to feedback both the selected FD components in addition to the indices of nonzero coefficients in the bitmap.

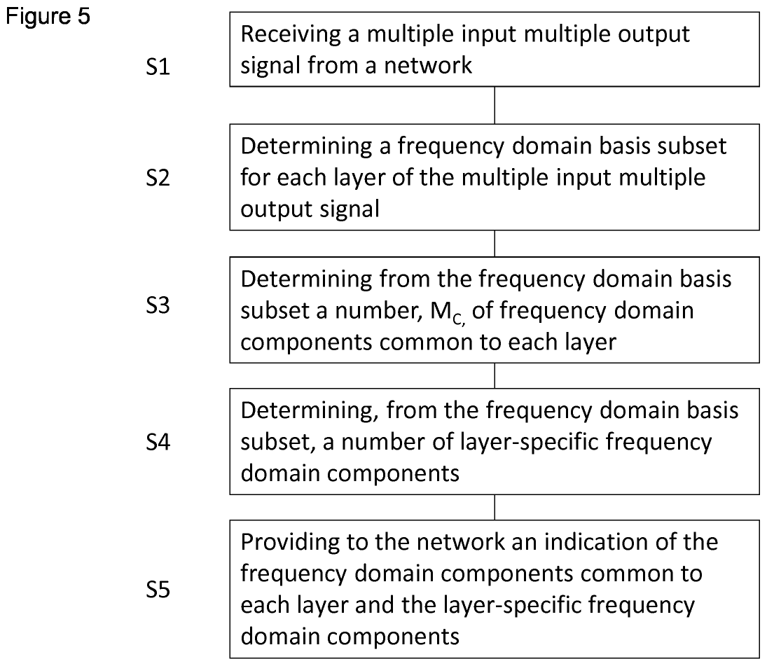

FIG. 5 shows a flowchart of a method according to an example embodiment.

In a first step, S1, the method comprises receiving a multiple input multiple output signal from a network.

In a second step, S2, the method comprises determining a frequency domain basis subset for each layer of the multiple input multiple output signal.

In a third step, S3, the method comprises determining from the frequency domain basis subset a number, M_{C}, of frequency domain components common to each layer.

In a fourth step, S4, the method comprises determining, from the frequency domain basis subset, a number of layer-specific frequency domain components.

In a fifth step, S5, the method comprises providing to the network an indication of the frequency domain components common to each layer and the layer-specific frequency domain components.

The method may be performed at a UE.

The indication may be provided in uplink control information (UCI). The signal may be a channel state information reference signal (CSI-RS). The signal may be received from a gNB

The method is based on the agreed upon type II FD compression and the same set of parameters that define the compressed CSI overhead will be reused. This set of parameters includes the number of selected FD components per layer, M, the total number of non-zero coefficients K₀, the length of the DFT basis vectors N₃ and the DFT basis oversampling factor O₃. We also retain the resolution of the amplitude and phase quantization in addition to the definition of PMI FD compression unit.

In addition to aforementioned parameters, the following parameters are defined:
M_{c}=number of common frequency domain components
Mₗ=number of layer specific frequency domain components ∀l=1 . . . RI
Lₗ=number of spatial domain beams ∀l=1 . . . RI
K_{1,c}=number of commonly mapped non-zero coefficients.
K_{1,l}=number of non-zero coefficients that are independently mapped per layer.
K₀=maximum total number of non-zero quantized coefficients across layers fed back to gNB.
K₁=actual total number of non-zero quantized coefficients across layers fed back to gNB.

DFT-based FD compression of the linear combination coefficients matrix W₂ was agreed upon in 3GPP meetings (RAN1 #95). Using an oversampled DFT matrix, PMI payload overhead may be reduced by leveraging FD correlation. In this method the same principle is retained and adapted to the case where RI>2.

When extending FD PMI compression to higher ranks, there are two main alternatives to choose from, namely, common or layer-specific FD basis subset selection. Choosing one of these options amounts to addressing a trade-off between overhead and flexibility.

In this method, while the FD basis subset selection can be independent, the signaling is hybrid.

The frequency domain basis subset for each layer may be determined independently, commonly or in a partially common manner. That is, the UE selects the FD basis subset for each layer, independently, or commonly or in a partially-common manner, depending on the specified approach. The UE then derives the parameter M_{c} which specifies the size of the common part of the bitmap.

For common FD basis subset selection, the UE sets M_{c}=M and signals the basis jointly for all layers.

For layer-/layer-group-specific (or independent) FD basis subset selection, the UE derives the size of the common basis subset M_{c}. In this case, M_{c} is the number of FD components that were selected by all layers. These components will constitute the common basis subset denoted by W_{f}^{c}.

For partially common selection, the UE selects M_{c} FD components jointly for all layers and M-M_{c} independently per each layer/layer-group. For partially common selection, M_{c} is defined so that the amplitude of the non-zero (NZ) coefficients with overlapping locations is maximized. That is, the UE may determine M_{C} such that a maximum number of NZ coefficients are concentrated in the first M_{c} FD components, where concentrated means that the FD vectors having the highest number of non-zero coefficients among the initially determined frequency domain basis subset, M.

M_{c} may be determined for a predefined number of layers, e.g., the first two layers of the layers of the MIMO signal or any other combination of layers of the layers of the MIMO signal.

The layer-specific FD components form RI different matrices Wₛ^{l} ∀l=1 . . . RI. The size of the layer-specific FD basis subset can be different across layers Mₗ, ∀l=1 . . . RI as in the considered alternatives.

The FD basis subset for each layer will then be the result of combining the common and layer-specific parts. More precisely, the FD basis per layer is given by

W_{f}^{l}=[W_{f}^{c} Wₛ^{l}], such that size (W_{f}^{l})=N₃×(M_{c}+Mₗ), ∀l=1 . . . RI

Distinguishing between layer-specific and common FD basis subsets for the different layers may provide several advantages. The overhead payload for FD component selection feedback may be reduced for high rank channels.

This approach may enable common indexing in the common FD basis subset.

The method may comprise determining non-zero coefficients commonly mapped to each layer, determining non-zero coefficients that are mapped independently per layer and providing an indication of the non-zero coefficients to the network.

After selecting the common and layer-specific FD components, the UE will have an FD compression basis per layer W_{f}^{l}=[W_{f}^{c} Wₛ^{l}], ∀l=1 . . . RI. Based on the latter, the UE computes the linear combination coefficients matrices \tilde{W}₂^{l}, ∀l=1 . . . RI.

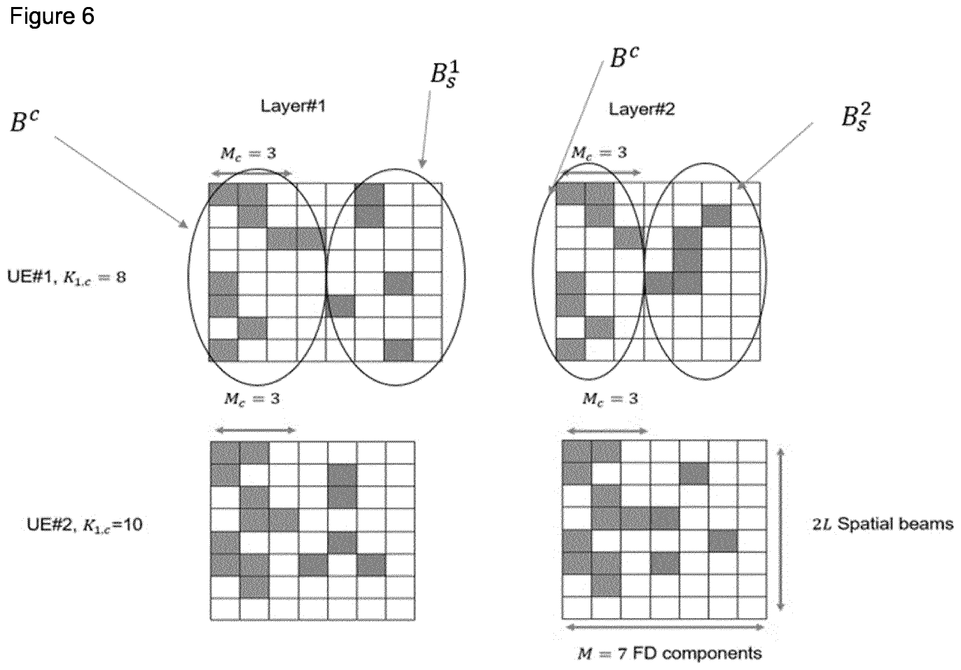

As mentioned above, the strongest coefficients of each layer may be associated with the common FD components (DFT tends to concentrate energy in the low-pass components) or independent from it. The UE uses this property when mapping the first K_{1,c} per layer. Indeed, the non-zero coefficients that are associated with the common FD basis subset will be mapped jointly across layers in the bit-map. The result of this will be a set of K_{1,c} indices that will be used by all layers. Note that the values of the commonly mapped coefficients are not correlated (each layer can associate a different value for each common index). An example of the adopted approach is shown in FIG. 6.

The UE construct a common FD basis of size M_{c}, containing the FD components that were selected by all layers. (M_{c}=M for common basis subset selection and M_{c}<M for independent basis subset selection and partially common basis subset selection).

When independent FD basis subset selection is enabled, the UE construct the layer-specific FD basis for each layer l=1 . . . RI such that M_{c}+Mₗ=M, ∀l=1 . . . RI.

The UE computes the indices of K_{1,c} commonly mapped non-zero coefficients in the common part of the bit-map which is of size 2L×M_{c}. To locate the location of the common part of the bit-map, the UE can consider a joint decision across all layers or compute the bit-map based on one layer (1^{st} layer) or any combination of layers and enforce it on other layers.

For each layer l=1 . . . RI, the UE computes the indices of K_{1,l} layer-specific non-zero coefficients. The values of K_{1,l}, l=1 . . . RI are chosen such that:

$$R I \times {K}_{1 , c} + {\sum }_{l = 1}^{RI} {K}_{1 , l} \leq {K}_{0}$$

Depending on the used indexing method, the overhead of non-zero coefficient subset selection is as follows

| Combinatorial indexing | Bitmap |
|---|---|
| $⌈ {log}_{2} ( \begin{matrix}2 L {M}_{c} \\ {K}_{1 , c}\end{matrix} ) ⌉ + {\sum }_{l = 1}^{RI} ⌈ {log}_{2} ( \begin{matrix}2 L {M}_{l} \\ {K}_{1 , l}\end{matrix} ) ⌉$ | $2 L {M}_{c} + 2 L \times ( {\sum }_{l = 1}^{RI} {M}_{l} )$ |

The overhead of the baseline approach, using independent indexing per layer, is given by

| Combinatorial indexing | Bitmap |
|---|---|
| $⌈ {log}_{2} ( \begin{matrix}2 L M \times RI \\ {K}_{0}\end{matrix} ) ⌉$ | 2LM × RI |

Consequently, the proposed approach for indicating NZC locations results in an overhead gain of 2LM_{c}(RI−1), when bitmap indexing is used and M_{c}+Mₗ=M, ∀l=1 . . . RI.

Considering an example where (M_{c}, L, RI) have the typical values of (3, 4, 4), the proposed scheme provides a 72 bits overhead gain in NZC subset selection.

Since the method distinguishes between common and layer parts in FD basis subset and NZC subset selection, part 2 in the two-part UCI shall be modified to mirror this distinction and reduce the subsequent overhead. The UCI will contain the following information.
UCI part 1:
   Number of non-zero coefficients K₁
   Number of common FD components M_{c}.
UCI part 2:
   Oversampling rotation factors (q₁, q₂, q₃).
   Layer-common, layer-specific or partially common spatial beams
   M_{c} common FD components across layers:

$$⌈ {log}_{2} ( \begin{matrix}{N}_{3} \\ {M}_{c}\end{matrix} ) ⌉ bits .$$

Mₗ layer-specific FD components ∀l=1 . . . RI:

$$⌈ {log}_{2} ( \begin{matrix}{N}_{3} - {M}_{c} \\ {M}_{l}\end{matrix} ) ⌉ bits .$$

Common NZC subset selection: 2LM_{c} bits.
Layer-specific NZC subset selection: 2LMₗ bits, ∀l=1 . . . RI.
Layer-specific strongest coefficient.
Quantized amplitudes per layer.
Quantized phases per layer.

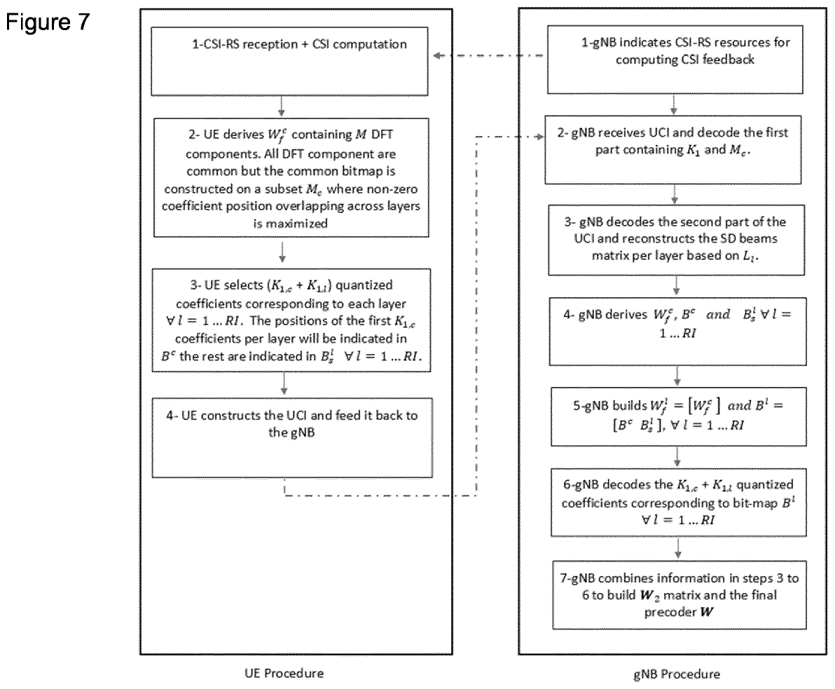

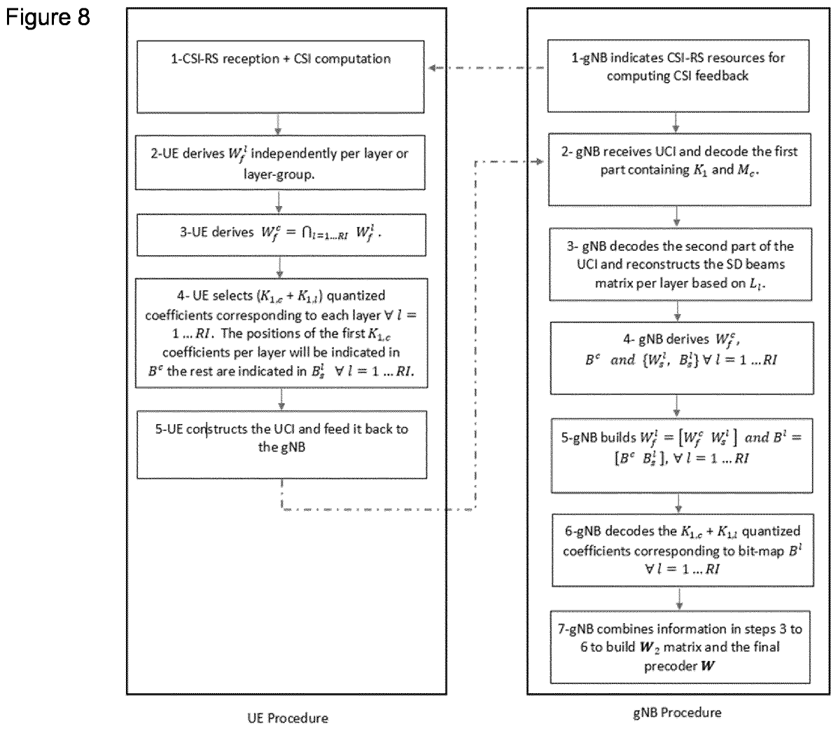

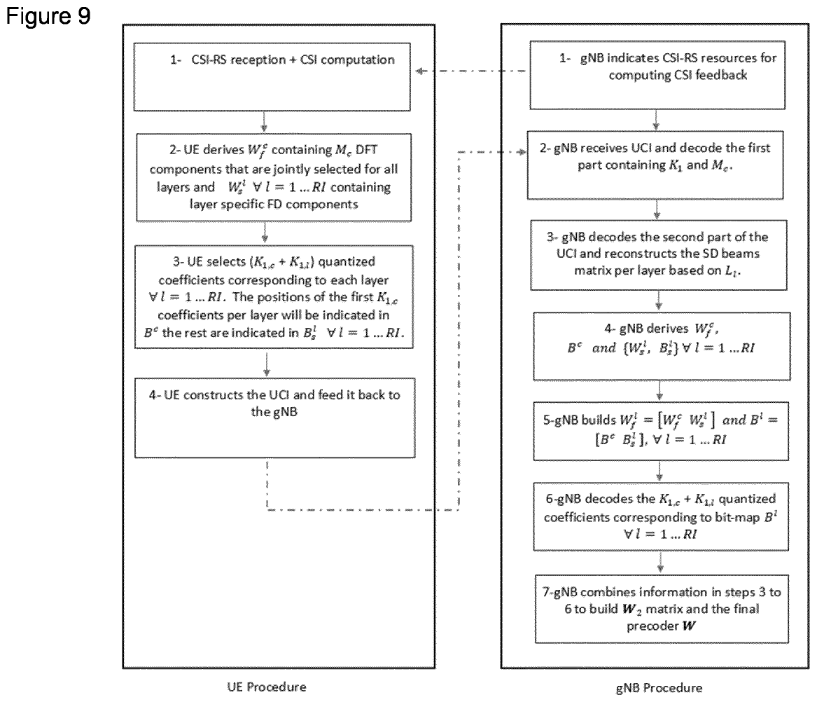

A more detailed description of the procedures at the UE and gNB sides are shown in FIGS. 7, 8 and 9 for all possible alternatives of FD component selection, namely, common FD component selection across layers, layer/layer-group specific FD component selection and the proposed partially common FD component selection, respectively.

The proposed method may enable accurate CSI with reduced overhead increment for high ranks (RI>2). The approach can be applied with different or similar numbers of SD beams per layer that may be Layer-common, layer-specific or partially common for all layers. The proposed approach can be applied with bitmap or combinatorial indexing.

The method may can be applied with any FD basis subset selection approach

The method may provide a CSI feedback procedure that extends the type II CSI framework to higher channel ranks (RI>2). A flexible scheme is proposed to reduce the feedback overhead where RI>2, based on type II CSI feedback FD compression. Common and layer specific parts of the UCI are defined to reduce the feedback overhead when RI≥2. This approach may leverage any correlation across layers in terms of FD component and non-zero coefficient indices selection.

Leveraging DFT properties and the likelihood of rank deficient channels, a flexible framework is proposed that may reduce the feedback overhead while maintaining accuracy. The FD component selection may reduce the overhead needed to signal the selected FD basis subset. The UCI bitmap design may be used with any FD component selection alternative resulting in a reduced overhead for signalling the locations of non-zero coefficients.

By distinguishing between common and layer-specific parts of the UCI any redundant information may be removed from the feedback.

The proposed method modifies mainly two sections of the UCI, namely, the feedback related to FD basis subset and non-zero coefficient selection, respectively. Regardless of the adopted approach for FD basis subset selection, common, partially common or independent across layers, the method adopts a hybrid signalling approach by distinguishing between common and layer specific sections. Indeed, part of the non-zero coefficients are jointly mapped which may substantially reduce the resulting overhead. In addition, any commonly selected FD components are signalled once in a specific section which also reduces the overhead contribution of FD basis subset selection.

The method may be implemented in a control apparatus as described with reference to FIG. 3.

An apparatus may comprise means for receiving a multiple input multiple output signal from a network, determining a frequency domain basis subset for each layer of the multiple input multiple output signal, determining from the frequency domain basis subset a number, MC, of frequency domain components common to each layer, determining, from the frequency domain basis subset, a number of layer-specific frequency domain components and providing to the network an indication of the frequency domain components common to each layer and the layer-specific frequency domain components.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to 5G NR, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various example embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Example embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Example embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed, there is a further embodiment comprising a combination of one or more embodiments with any of the other embodiments previously discussed.

1-13. (canceled)

14. An apparatus comprising at least one processor and at least one memory including a computer program code, the at least one memory and computer program code configured to, with the at least one processor, cause the apparatus at least to:
receive a multiple input multiple output signal from a network;
determine a frequency domain basis subset for each layer of the multiple input multiple output signal;
determine from the frequency domain basis subset a number, M_{C}, of frequency domain components common to each layer;
determine, from the frequency domain basis subset, a number of layer-specific frequency domain components; and
provide to the network an indication of the frequency domain components common to each layer and the layer-specific frequency domain components.

15. An apparatus according to claim 14, wherein the at least one memory and computer program code configured to, with the at least one processor, cause the apparatus at least to provide the indication in uplink control information.

16. An apparatus according to claim 14, wherein the at least one memory and computer program code configured to, with the at least one processor, cause the apparatus at least to:
determine the frequency domain basis subset for each layer independently, commonly or in a partially common manner.

17. An apparatus according to claim 14, wherein the at least one memory and computer program code configured to, with the at least one processor, cause the apparatus at least to determine M_{C} such that a maximum number of non-zero coefficients are concentrated in the M_{C} frequency domain components.

18. An apparatus according to claim 14, wherein M_{C} is determined from a predefined number of layers.

19. An apparatus according to claim 18, wherein the predefined number of layers is the first two layers of the layers or any combination of the layers.

20. An apparatus according to claim 14, wherein the at least one memory and computer program code configured to, with the at least one processor, cause the apparatus at least to:
determine non-zero coefficients commonly mapped to each layer; and
provide an indication of the non-zero coefficients to the network.

21. An apparatus according to claim 14, wherein the at least one memory and computer program code configured to, with the at least one processor, cause the apparatus at least to:
determine non-zero coefficients that are mapped independently per layer; and
provide an indication of the non-zero coefficients to the network.

22. An apparatus according to claim 14, wherein the at least one memory and computer program code configured to, with the at least one processor, cause the apparatus at least to provide the indication of the non-zero coefficients in uplink control information.

23. An apparatus according to claim 14, wherein the signal is a channel state information reference signal.

24. A method comprising:
receiving a multiple input multiple output signal from a network;
determining a frequency domain basis subset for each layer of the multiple input multiple output signal;
determining from the frequency domain basis subset a number, M_{C}, of frequency domain components common to each layer;
determining, from the frequency domain basis subset, a number of layer-specific frequency domain components; and
providing to the network an indication of the frequency domain components common to each layer and the layer-specific frequency domain components.

25. A non-transitory computer readable medium having stored thereon a set of computer readable instructions that, when executed by at least one processor, cause an apparatus to at least perform:
receiving a multiple input multiple output signal from a network;
determining a frequency domain basis subset for each layer of the multiple input multiple output signal;
determining from the frequency domain basis subset a number, M_{C}, of frequency domain components common to each layer;
determining, from the frequency domain basis subset, a number of layer-specific frequency domain components; and
providing to the network an indication of the frequency domain components common to each layer and the layer-specific frequency domain components.
